(19) United States
(12) Patent Application Publication
(10) Pub. No.: US 2017/0039503 A1
(43) Pub. Date: Feb. 9, 2017

(54) PRODUCTIVITY EVALUATION SYSTEMS AND METHODS

(71) Applicant: Wal-Mart Stores, Inc., Bentonville, AR (US)

(72) Inventors: Nicholaus A. Jones, Fayetteville, AR (US); Robert J. Taylor, Rogers, AR (US); Matthew A. Jones, Bentonville, AR (US)

(21) Appl. No.: 15/229,858

(22) Filed: Aug. 5, 2016

Related U.S. Application Data
(60) Provisional application No. 62/201,190, filed on Aug. 5, 2015.

(51) Int. Cl. G06Q 10/06

(52) U.S. Cl. CPC G06Q 10/06398; G06Q 10/063114

(57) ABSTRACT

Methods, systems and apparatus are provided that evaluates work productivity. Some embodiments provide a system comprising a workforce evaluation system comprising: a control circuit; and a memory storing computer instructions that when executed by the control circuit cause the control circuit to: identify a first work task and identify an amount of work performed in working on the first work task; identify a paired second work task paired with the first work task; predict an amount of work to be performed in working on the second task as a function of the amount of work performed in working on the first task; identify an amount of work that is performed in working on the second task; cause an anomaly notification to be generated when the amount of work performed in working on the second task is not within a threshold of the predicted amount of work to be performed.

### CROSS-REFERENCE TO RELATED APPLICATION

This application claims the benefit of U.S. Provisional Application No. 62/201,190, filed Aug. 5, 2015, and is incorporated herein by reference in its entirety.

### TECHNICAL FIELD

These teachings relate generally to work productivity, and more particularly to devices, systems and methods to track, evaluate and/or enhance work productivity.

### BACKGROUND

In modern retail environments, numerous employees are responsible for supporting customers and getting thousands of products in positions to be purchased by customers. The shopping facilities must order and receive large amounts of inventory to provide customers with access to all these products. Still further, the shopping facilities must distribute these products to the sales floor to be available for purchase, and provide services to allow customers to purchase products.

There is a need to improve the customer experience and work productivity. There is a further need to improve work efficiency and productivity of workers at a shopping facility.

### BRIEF DESCRIPTION OF THE DRAWINGS

The above needs are at least partially met through provision of embodiments of systems, devices, and methods designed to track and improve efficiencies and work productivity at shopping facilities, such as described in the following detailed description, particularly when studied in conjunction with the drawings, wherein:

FIG. 1 illustrates a simplified block diagram of an exemplary efficiency and productivity tracking system configured to track and improve efficiency and productivity at a shopping facility, in accordance with some embodiments;

FIG. 2 illustrates a simplified block diagram of an exemplary workforce evaluation system, in accordance with some embodiments;

FIG. 3 illustrates a simplified block diagram of an exemplary task management system, in accordance with some embodiments;

FIG. 4 shows a simplified flow diagram of an exemplary process of tracking, evaluating and managing workforce and workforce productivity, and identifying work inefficiencies, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The ability to track work efficiency and performance is very difficult in retail environments because of the large number of products and typically the relatively large number of workers to distribute products to the sales floor, support customers and maintain the shopping facility. Some embodiments have identified related or interdependent tasks that are performed at a shopping facility that can be used in part to track performance and efficiency of workers and shopping facilities. Further, some embodiments utilize the work performed in completing one or more tasks in evaluating the performance relative to one or more other tasks.

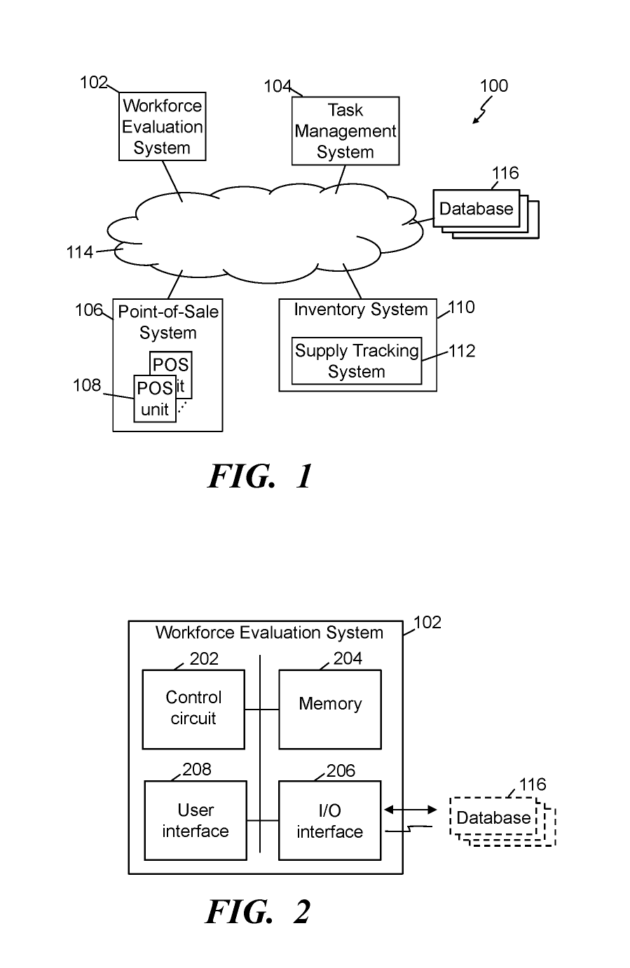

FIG. 1 illustrates a simplified block diagram of an exemplary efficiency and productivity tracking system 100 configured to track and improve efficiency and productivity at a shopping facility, in accordance with some embodiments. The tracking system 100 includes one or more workforce evaluation systems 102, one or more task management systems 104, a point-of-sale system 106 that includes one or more point-of-sale units 108, and one or more inventory systems 110, which may further include one or more supply tracking systems 112. The workforce evaluation system (WES) 102 is in communication with the task management system 104, the point-of-sale units 108, and the inventory system 110 through one or more communication and/or data networks 114, such as the Internet, one or more wide area networks (WAN), one or more local area networks (LAN), one or more cellular communication networks, other such networks, or combinations of two or more of such networks that provide wired, wireless or a combination of wired and wireless communication. FIG. 1 shows the workforce evaluation system, task management system, and inventory system as distinct systems. In some embodiments, however, one or more of the task management system and inventory system may be implemented partially or fully through the workforce evaluation system. Additionally or alternatively, one or more of the workforce evaluation system, task management system, and inventory system may be implemented through a central system, such as a central system of a retail chain. Some embodiments may further include one or more databases 116 that store information such as, but not limited to, employee information, employee profiles, previous work productivity and/or evaluation data, task assignments, workforce allocation, workforce predictions, task allocation information, task predictions, inventory information, product information, product profiles, customer profile information, sales information, and the like.

In some embodiments, the workforce evaluation system 102 receives data and information directly or indirectly from one or more of the task management system 104, point-of-sale units 108, inventory system 110, remote systems (central control, a retail chain headquarters, and/or other such sources) in tracking and evaluating workforce and/or shopping facility efficiency and/or productivity. Based on the evaluation the workforce evaluation system may cause one or more notifications be generated regarding the determined evaluation that can be used to enhance productivity and/or efficiency. For example, in some instance, the workforce evaluation system can detect workforce and/or task completion anomalies and cause a notification to be generated to notify a shopping facility supervisor, manager, regional manager, retail chain headquarters and/or other such recipients, and typically a combination of such recipients of the anomalies.

The workforce evaluation system takes advantage of identified relationships and/or interdependencies between tasks performed at a shopping facility. For example, some embodiments track and/or determine shopping facility and/or workforce productivity and/or efficiency of one task based on the amount of work done in performing and/or completing another one or more tasks at the shopping facility. In some applications, the workforce evaluation system is notified of pairings of tasks, and/or correlates or pairs two or more tasks performed at a shopping facility, and evaluates efficiency and/or productivity in performing one of those tasks at the shopping facility as a direct dependency of the amount of reported and/or actual work performed in working on and/or completing the other of the one or more paired tasks.

The task management system 104 can be configured to schedule, receive and/or predict tasks that are to be performed by the workforce and the extent (size, complexity, etc.) of the tasks. Tasks may be determined based in whole or typically in part on sales information provided by the point-of-sale units 108 and inventory and/or inventory distribution based on information provided by the inventory system and/or supply tracking system 112. Tasks may be scheduled by store and/or department managers, a central control, a retail chain headquarters, a product management system, a financial analysis group of a retail chain, regional or corporate office, the inventory system 110 (e.g., in response to receiving a shipment of inventory at the shopping facility, detection of a threshold amount of sales of one or more products, and the like), and other such sources. For example, the tasks can include but are not limited to shipment inventory intake, product binning, product picking, restocking, price changes, modular changes, and the like. Additionally or alternatively, the task management system 104 may couple with the inventory system 110 and/or the point-of-sale system 106, and identify and/or schedule tasks to be performed. For example, the task management system may be configured to identify multiple different work tasks intended to be performed at the shopping facility based at least in part on the registered sales (e.g., detected by the point-of-sale units) and the shipment deliveries at the shopping facility.

The task management system and/or the workforce evaluation system, in some implementations, further track completion of some or all of the different work tasks. For example, workers may enter information directly into the task management system corresponding to the initiation, performance and/or completion of one or more tasks, and/or other systems may provide information that can be used by the task management system in tracking the progress and/or completion of one or more tasks. For example, the inventory system may provide information about products that have been stocked based on workers scanning one or more product identifiers and/or case identifiers (e.g., bar codes) as the products are removed from trucks, being picked and/or restocked. Similarly, workers in performing one or more tasks may enter progress and/or completion information through a user interface (e.g., a computer terminal, through a scanner (e.g., portable scanner device), and/or other such devices). This information can be used by the workforce evaluation system 102 and/or the task management system 104.

In some instances, further tasks may be considered, such as tasks correspond to the maintenance of the shopping facility as well as the support of customers (e.g., workers operating the point-of-sale units 108, customer service, and other such support tasks). Many tasks performed at a shopping facility are interdependent in that the occurrence or predicted need of workers performing one task results in the need to complete a corresponding task, similar tasks are performed in two different departments of the shopping facility, or a task is shared across multiple regions or departments of a shopping facility. For example, the delivery of products to a shopping facility triggers a task to unload the products. The unloading often triggers binning and/or picking tasks and distribution to a back storage area. Picking tasks often trigger restocking or re-shelving tasks to move the products to the sales floor. Further, the restocking of the shelves often corresponds to an increase in sales or maintains a level of sales, which causes point-of-sale tasks.

The inventory system 110 can be configured to track inventory through deliveries, sales, orders, shipment requests, and the like. In some implementations, the inventory system communicates with one or more distribution centers in submitting orders, receiving status information on orders and deliveries, and the like. Further, the inventory system may be in communication with a central controller, headquarters, etc., in receiving information about inventory, expected inventory, corrections and the like. Again, the point-of-sale system 106 further provides information about the sales of products that is a direct indicator of the number of products being removed from the shelves. The sales and/or rate of sales based on information provided by the point-of-sale system can further provide an indication of predicted deliveries. Similarly, the task management system may utilize the point-of-sale information in predicting tasks and the workforce that would be desirable to implement the tasks.

The supply tracking system receives and/or tracks product shipment requests by the shopping facility. Further, in some implementations, the supply tracking system tracks predicted, in route and/or actual product deliveries to the shopping facilities. This information again can be provided to the task management system to be used in assigning and/or scheduling tasks and/or allow workers to be assigned to perform the tasks corresponding to the delivery of products.

Additionally, in some embodiments one or more databases 116 may be accessible by the workforce evaluation system 102, task management system 104, inventory system 110 and/or the point-of-sale system 106. Such databases may be integrated into the workforce evaluation system or separate from it. The one or more databases may be at the location of the shopping facility or remote from the shopping facility. Regardless of location, the one or more databases comprise memory to store and organize certain data for use by at least the workforce evaluation system. In some embodiments, the at least one database 116 may store data pertaining to one or more of: work completed, rates of completion, scheduled tasks, historic data (e.g., times to complete tasks relative to amounts of product corresponding to the task, workforce efficiencies, pairings between tasks, worker ratings, worker efficiencies, inventory information, product information, sales information, task allocation, task prediction, workforce allocation, workforce predictions, and so on.

FIG. 2 illustrates a simplified block diagram of an exemplary workforce evaluation system 102, in accordance with some embodiments. The workforce evaluation system, in part, is configured to evaluate work performed relative to a first task in determining efficiency and/or productivity based on an amount of work and/or time to perform a second task. In this example, the workforce evaluation system includes a control circuit 202, memory 204, and one or more input/output (I/O) interfaces 206. Further, the workforce evaluation system, in some implementations, may include one or more user interfaces 208 configured to allow users to interact with the workforce evaluation system.

In some embodiments, the workforce evaluation system and/or the control circuit 202 can be implemented through one or more servers and/or computers operated at, remote from or a combination of at and remote from a corresponding shopping facility. Further, the plurality of computers and/or servers may be distributed over one or more communication networks (e.g., the communication network 114), and may be geographically distributed while still being communicationally coupled to cooperatively operate to perform the functions of the workforce evaluation system.

The control circuit 202 of the workforce evaluation system typically comprises one or more processors and/or microprocessors. The control circuit couples with and/or includes the memory 204. Generally, the memory 204 stores the operational code or one or more sets of instructions that are executed by the control circuit 202 and/or processor to implement the functionality of the workforce evaluation system. In some embodiments, the memory 204 may also store some or all of particular data that may be needed in evaluating workforce efficiency, productivity, rate of completion, and other such evaluations, and generating or causing to be generated one or more reports and/or notifications. In some implementations, the memory further stores code, instructions and corresponding data to allow the workforce evaluation system to propose and/or implement modifications in attempts to improve workforce efficiency and/or productivity. Such data may be pre-stored in the memory or be received, for example, from a central controller, headquarters, regional manager, task management system, shopping facility, workers at the shopping facility, other sources, or combinations of such sources.

It is understood that the control circuit may be implemented as one or more processor devices as are well known in the art. Further, the control circuit may be implemented through multiple processors dispersed over the communication network. Similarly, the memory 204 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 204 is shown as internal to the workforce management system; however, the memory 204 can be internal, external or a combination of internal and external memory. Additionally, the workforce management system may include a power supply (not shown) and/or it may receive power from an external source. In some instances, the control circuit 202 and the memory 204 may be integrated together, such as in a microcontroller, application specification integrated circuit, field programmable gate array or other such device, or may be separate devices coupled together. In some applications, the control circuit 202 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 206 allow wired and/or wireless communication coupling of the workforce management system to external components, such as the task management system 104, point-of-sale system 106, inventory system 110, supply tracking systems 112, workers' and/or customers' user interface units (e.g., smart phones, tablets, computers, etc.), the databases 116, shopping facility systems, distribution center systems, and other such components. Accordingly, the I/O interface 206 may include any known wired and/or wireless interfacing device, circuit and/or connecting device, such as but not limited to transceivers, receivers, transmitters, and the like. For example, in some implementations, the I/O interface 206 provides wireless communication in accordance with one or more wireless protocols (e.g., cellular, Wi-Fi, Bluetooth, radio frequency (RF), other such wireless communication, or combinations of such communications). In some embodiments, the I/O interface includes one or more transceivers configured to couple with and transmit and/or receive communications from over the distributed communication network 114.

One or more user interfaces 208 can be included in and/or couple with the workforce management system, and can include substantially any known input device, such one or more buttons, knobs, selectors, switches, keys, touch input surfaces and/or displays, etc. Additionally, the user interface may include one or more output display devices, such as lights, visual indicators, display screens, touch screen, etc. to convey information to a user, such as workforce efficiency, notifications of anomalies, reports, efficiency goals, scheduled workforce allocation, proposed modifications to workforce allocation, product information, inventory information, sales information, scheduled tasks, predicted tasks, other such task management information, and other workforce information, status information, history information, and/or other such information. While FIG. 2 illustrates the various components being coupled together via a bus, it is understood that the various components may actually be coupled to the control circuit 202 and/or one or more other components directly.

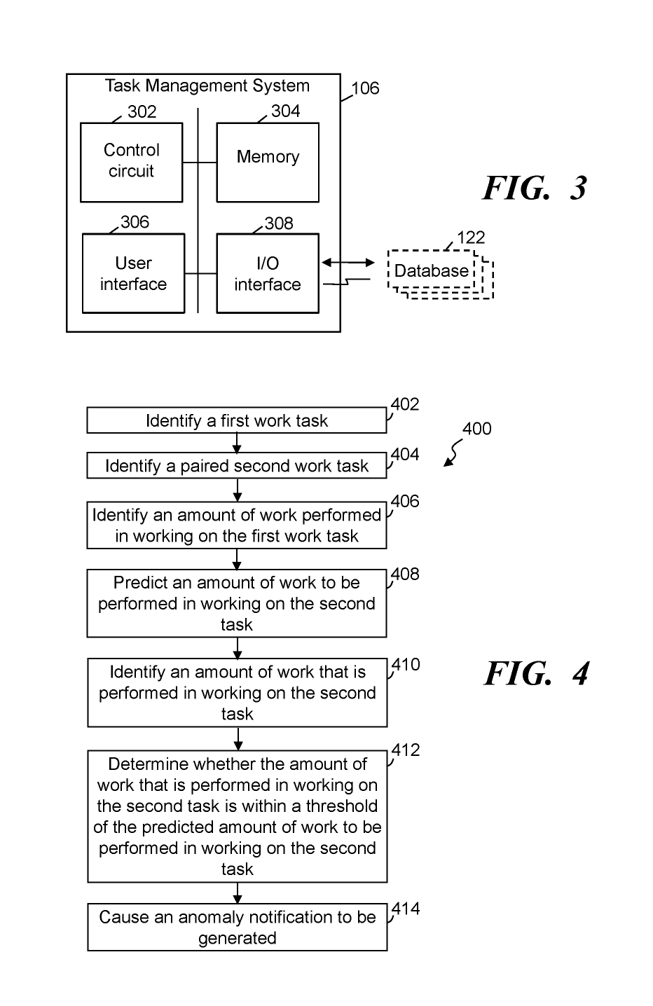

FIG. 3 illustrates a simplified block diagram of an exemplary task management system 104, in accordance with some embodiments. In this example, the task management system includes a control circuit 302, memory 304, and one or more input/output (I/O) interfaces 306. In some implementations, the task management system includes one or more user interfaces 308 configured to allow users to interact with the task management system. The task management system and/or the control circuit 302 of the task management system can be implemented through one or more servers and/or computers operated at, remote from or a combination of at and remote from one or more shopping facilities. Further, the plurality of computers and/or servers may be distributed over one or more communication networks (e.g., the communication network 114), and may be geographically distributed while still being communicationally coupled to cooperatively operate to perform the functions of the task management system. Additionally or alternatively, the control circuit 302 may be implemented through one or more processors and/or microprocessors, which may be at a single location or dispersed over the communication network.

The control circuit couples with and/or includes the memory 304. Generally, the memory 304 stores the operational code or one or more sets of instructions that are executed by the control circuit 302 and/or processor to implement the functionality of the task management system. In some embodiments, the memory may also store some or all of particular data, codes and/or instructions that may be needed in receiving, scheduling and tracking tasks and/or work allocation of the various tasks. Such data may be pre-stored in the memory or be received, for example, from the workforce evaluation system, inventory system 110, shopping facility supervisor, manager, regional manager, retail chain headquarters, other sources, or combinations of such sources.

The memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the task management system; however, the memory 304 can be internal, external or a combination of internal and external memory. Additionally, the task management system may include a power supply (not shown) and/or it may receive power from an external source. In some instances, the control circuit 302 and the memory 304 may be integrated together, such as in a microcontroller, application specification integrated circuit, field programmable gate array or other such device, or may be separate devices coupled together. In some applications, the control circuit 302 comprises a fixed-purpose hard-wired platform or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein.

The one or more I/O interfaces 306 allow wired and/or wireless communication coupling of the task management system to external components, such as the workforce evaluation system 102, point-of-sale system 106, inventory system 110, customers' user interface units (e.g., smart phones, tablets, computer, laptop, etc.), the databases 116, shopping facilities systems, distribution center systems, central controller, regional office, and other such components. Accordingly, the I/O interface 306 may include any known wired and/or wireless interfacing device, circuit and/or connecting device, such as but not limited to transceivers, receivers, transmitters, and the like. For example, in some implementations, the I/O interface provides wireless communication in accordance with one or more wireless protocols (e.g., cellular, Wi-Fi, Bluetooth, radio frequency (RF), other such wireless communication, or combinations of such communications). In some embodiments, the I/O interface includes one or more transceivers configured to couple with and transmit and/or receive communications from over the distributed communication network 114.

In some implementations, the task management system further includes and/or couples with one or more user interfaces 308, which can include substantially any known input device, such one or more buttons, knobs, selectors, switches, keys, touch input surfaces and/or displays, etc. Additionally, the user interface may include one or more output display devices, such as lights, visual indicators, display screens, touch screen, etc. to convey information to a user, scheduled tasks, scheduled workforce, scheduled workloads, predicted workloads, and/or other such information. While FIG. 3 illustrates the various components being coupled together via a bus, it is understood that the various components may actually be coupled to the control circuit 302 and/or one or more other components directly.

In some embodiments, the inventory system 110 and/or point-of-sale system 106 similarly include a control circuit, memory, and one or more input/output (I/O) interfaces. Further, the inventory system and/or point-of-sale system 106 often include one or more user interfaces. Still further, in at least some applications implementations, some of the point-of-sale system is implemented through the inventory system with the point of sale units providing sales information to the inventory system that utilizes the sales information in tracking sales and inventory.

FIG. 4 shows a simplified flow diagram of an exemplary process 400 of tracking, evaluating and managing workforce and workforce productivity, and identifying work inefficiencies, in accordance with some embodiments. Further, in some implementations, the process is implemented at least in part through the workforce evaluation system at a shopping facility configured to enhance work productivity at the shopping facility. Again, the evaluation of workforce often considers the work and/or amount of work (e.g., in hours) performed in working on and/or completing one task relative to the work and/or amount of work performed in working on another task. Further, the evaluation between tasks typically includes considering tasks that have some dependency. As some examples, some evaluations consider delivery tasks versus binning tasks, binning tasks versus picking tasks, picking tasks versus stocking tasks, stocking tasks versus sales floor tasks, administration tasks or work versus tasks to put products on shelves or other such product support structures at the shopping facility, administration work or tasks in one area (e.g., inventory evaluation and tracking) versus administration work or tasks in another area (e.g., price changing), and other such pairing of tasks.

In step 402, a first work task being performed or completed at a shopping facility is identified. The first work task is one work task of multiple different work tasks intended to be performed at the shopping facility, which often are based at least in part on registered sales and shipment deliveries at the shopping facility. Again, the multiple work tasks are performed by a workforce of one or more employees at the shopping facility. In step 404, a paired second work task is identified that is paired with the first work task. In some implementations, the identification of the second work task is based on a predefined pairing. Additionally or alternatively, the pairing may be based on an interdependency between the two work tasks. For example, in some embodiments, an amount of work to be performed for the paired second work task is specifically dependent on an amount of work performed for the first work task, and/or the amount of work to be performed for the paired first work task is specifically dependent on the amount of work performed for the second work task.

In step 406, an amount of work performed by the workforce at the shopping facility in working on the first work task is identified. This may be based on workers specifying an amount of work (e.g., workers logging in a computer system and/or work tracking system a number of cases binned, a number of products stocked on shelves, a number of cases, pallets and the like removed from trucks, etc.); tracking scans of product identifiers, case identifiers, pallet identifiers, or other identifier that can be scanned by a scanner (e.g., optical scanner); identifying numbers of products removed from a truck based on delivery information (e.g., invoices, shipping records, etc.); time entered by worker(s) specifying duration of work performed; number of products moved (e.g., binning, stocking, etc.); and/or other such information. Further considerations may include the number of workers that work on a task, priorities of tasks, whether tasks are interrupted by higher priority tasks, and other such factors. Additionally, the amount of work may be defined by a number of products, a duration of time, a work effort factor that can correspond to an effort needed to perform the task (e.g., more physically demanding tasks may be given a higher work effort factor than less physically demanding task, complex tasks may be given a higher work effort factor than less complex tasks, etc.), or other defined parameter and/or combinations of such parameters.

In some embodiments, the workforce evaluation system and/or the task management system may convert work performed for one task defined by a first parameter (e.g., number of products) into a different parameter (e.g., converted to a time or hours worked parameter). For example, a number of products removed from a truck may be converted to work hours based on one or more conversion formulas, which may be defined based on historic amounts of time to unload the same or similar number of trucks of similar or the same number and/or type of products and/or packaging of products. Other embodiments use tables correlating number of products relative to durations of time and/or number of workers in determining amounts of work performed. Additionally or alternatively, a central control (e.g., a retail chain headquarters, a financial analysis group of a retail chain, regional or corporate office, etc.) may predefine an amount of work for a task based on size and/or complexity of the task. Further, in some embodiments, the conversion may be confirmed based on one or more other factors, such comparing a calculation based on a number of products binned can be compared to one or more workers reported amount of time spent on performing the binning of the product. The evaluation of the second task, in some instances, is based on the first task being completed. The workforce evaluation system can identify that the first work task is completed, and then identifies the amount of work performed by the workforce in working on the first work task after the first task is completed.

In step 408, an amount of work to be performed in working on the second task is predicted as a function of the amount of work performed in working on the first task. In some instances, the prediction is based on historic data. For example, one or more tables can be assembled (e.g., central control, a retail chain headquarters, a product management system, a financial analysis group of a retail chain, regional or corporate office) defining predicted work correlations between pairs of tasks and the size, complexity, physical nature and/or other such factors (e.g., historically it has taken X amount of work hours to perform the second task when Y amount of work is performed in working on the first task). Statistical evaluation of historic data can be considered, e.g., average, median, standard deviation relationships between amounts of work performed on paired tasks. Additionally or alternatively, one or more prediction algorithms can be applied in predicting an amount of work (e.g., (X quantity of product binned)×(Y number of workers)×(Z duration factor)=amount of work to stock the binned products); where the Z duration factor may be multiplier corresponding to an expected additional amount of time to restock than to bin due to the need for the worker to open cases and neatly place products). As another example, a duration factor may be 1.5 when it is anticipated it would take one and a half times the duration to stock shelves than to bin the products to be shelved. Typically, however, historic data is statically evaluated for numerous different tasks and for numerous different products, and tables can be generated defining expected relationships between the various factors (e.g., quantity of product, complexity of the task, number of workers available, etc.).

In step 410, an amount of work that is performed by the workforce at the shopping facility in working on the second task is identified. This information may be obtained similar to step 406 (e.g., based on worker reportings, based on quantity of product moved, etc.). Further, the determined amount of work may be converted to correspond to and/or aid in comparing to the amount of work performed relative to the first task (e.g., from “quantity of product” to “hours worked”, etc.). Further, the amount of work in performing the second task is typically limited to work performed within a predetermined period of time and often is dependent on the first task and when the work was performed in working on the first task and/or when the first task was completed. Additionally, other factors may be considered such as complexity of the work, number of workers, whether there was an interruption, priority, time of day the work was performed, and the like, or combination of two or more of such. For example, the evaluation of the second task can be restricted to work performed within a threshold time of the first task being completed. The workforce evaluation system can, in identifying the amount of work that is performed by the workforce in working on the second task, limit the identification of the amount of work performed in working on the second task to the work that is performed within a threshold time of identifying the completion of the first task. The threshold time may be a fixed duration (e.g., five hours, 24 hours, or some other time) or may vary. Whether the duration is fixed and/or by how much the duration varies can depend on one or more factors, such as but not limited to the type of products (e.g., perishable products may have a shorter threshold than non-perishable goods), complexity of the first and/or second task, expected time to complete the first and/or second task, available workforce, whether work on the second task is interrupted (e.g., by a manager, a higher priority task, or the like), and other such factors.

In step 412, it is determined whether the amount of work that is performed in working on the second task is within a threshold of the predicted amount of work to be performed in working on the second task. The threshold can vary depending on one or more factors, such as the tasks being evaluated, the differences between tasks, historic differences, and the like. Further, the threshold can be based on a statistical evaluation of historic data, and/or acceptable margins of error (e.g., which may be based on business decisions, trying to improve efficiency, trying to limit variation, and the like).

In step 414, the control circuit of the workforce evaluation system can cause an anomaly notification to be generated when the determined amount of work performed in working on the second task is not within the threshold of the predicted amount of work to be performed. The anomaly often indicates an inconsistency between the paired work tasks and the work being done for each of the paired tasks. This can result, for example, because work efficiency is inconsistent, workers are reporting work being done when not actually doing the work, work forces are being diverted to other tasks, and other such factors.

The process 400 can be extended to evaluating other related and/or paired tasks. For example, a third task may be paired with one or both the first and second tasks. Accordingly, some embodiments evaluate a third task, which may be based on predicted work for the second task and/or the third task. The workforce evaluation system can identify a paired third work task that is paired, for example, with the second work task with an amount of work to be performed for the paired third work task is specifically dependent on the predicted amount of work performed for the second work task. The amount of work to be performed in working on the third task can be predicted as a function of the predicted amount of work to be performed in working on the second task. The third task can further be evaluated by identifying an amount of work that is actually performed by the workforce at the shopping facility in working on the third task, and causing an anomaly notification to be generated when the determined amount of work performed in working on the third task is not within a threshold of the predicted amount of work to be performed in working on the third task.

In some instances, the some or all of the work performed in completing the third task may actually occur prior to the work performed on the first task. As such, the paired third work task can be identified that is paired with the first work task, where the amount of work to be performed for the paired first work task may be specifically dependent on an amount of work performed in completing the third work task. An expected amount of work that should have been performed in working on a third task can be determined as a function of the amount of work performed in working on the first task. An actual amount of work that was performed by the workforce at the shopping facility in working on the third task can be identified (e.g., based on records, worker reports, scans, etc.). Again, an anomaly notification can be generated when the determined amount of work performed in working on the third task is not within a threshold of the work performed in working on the first task.

By identifying paired tasks, the efficiency and/or productivity in performing one task can be evaluated based on the amount of work performed by the workforce at the shopping facility in performing the paired task. Further, inefficiencies between areas or departments of a shopping facility can be identified, allowing an identification of areas of the shopping facility that are being neglected and/or an ineffective use of workforce in one or more departments. In some embodiments, the workforce evaluation system can be configured to identify one or more areas, regions, departments, or the like of the shopping facility that are being neglected as a function of a lack of work being performed in completing a second task based on the workload being performed on the first task, which may be in a different department. For example, a department manager may be pulling workers from other departments to perform one or more tasks in that department. As a result, other tasks intended to be performed in other departments may be delayed because the workforce has been reassigned. The detection of an anomaly allows the management of the shopping facility to evaluate the use of the workforce and determine whether that reassignment should continue to occur, whether additional workforce should be scheduled, or other action taken.

As described above, in evaluating work productivity, inefficiencies and/or workforce availability, some embodiments consider multiple metrics or factors. The evaluation can be dependent on the paired tasks, whether the tasks are completed, size and/or complexity of the task and other such metrics. For example, some embodiments consider the timing of the tasks and quantity of the tasks in performing the evaluation. The timing between tasks is typically dependent on when the workforce is available to perform the tasks (e.g., shopping facility work hours, whether there restrictions on when tasks can be performed, etc.).

Often, the paired tasks should be completed within a threshold time period of each other. For example, often pairs of tasks should be completed within 24 hours of each other. Some embodiments wait for the second task to complete before evaluating the efficiency relative to at least the second task in order to determine the timing of the task. However, some efficiency information can be identified based on an incompletion of the second task within the threshold time. Workforce anomalies can be detected as a function of the interdependence of the task, as well as at least the timing of the tasks and the quantity, size and/or complexity of the task. For example, in many instances when products are not binned within a threshold time after a delivery (e.g., 24 hours), then an anomaly may be reported indicating that the binning team is not working correctly. Some embodiments determine a two way task competition (e.g., did the occurrence and/or size of the first task justify the initiation and/or completion of the second task). Typically, the evaluation of the two tasks can include an evaluation of both tasks based on the other task, and does not have to be restricted to evaluating in one direction. For example, the evaluation can determine based on a quantity of the second task whether the first task was not recorded properly. Similarly, with tasks that are performed at the same or similar times (e.g., administrative tasks from two different parts or departments of a shopping facility) the time can be replaced with store region or department).

The reported anomaly can be included in a report, which may be electronically saved and accessible to management, communicated to one or more individuals and/or departments, added to a log that can be accessed and/or communicated, or other such notification. In some instances, for example, a department manager and/or shopping facility manager may receive a text message of one or more anomalies. In other instances, a report of multiple anomalies may be compiled and communicated as a text message, email or the like to a department manager and/or shopping facility manager. Further, a regional manager and/or chain wide management team may receive the report, or a summary report that lists anomalies over a period of time and/or includes a rating of one or more departments of one or more shopping facilities and/or one or more entire shopping facilities (e.g., efficiency ratings based on a number of anomalies, an efficiency ratio of anomalies to number of tasks, and/or other such information).

As another example, it may be determined based on the evaluation between deliveries and product binning, that the amount of binning being performed within one or more threshold times relative to the one or more deliveries is less than predicted by a threshold amount, the anomaly can be generated. The management can evaluate the anomaly and determine, for example, the binning workers might need more help or that the binning workers are not working at levels that are satisfactory. The detection of similar anomalies at multiple shopping facilities may indicate more of an institutional problem and further evaluation may be needed to address this inefficiency, and/or an adjustment to expectations may be needed throughout the multiple shopping facilities. Typically, when considering two or more paired tasks that are completed within relative threshold periods, the evaluation is more dependent on the quantity that the workforce completes between the two tasks and/or the rate at which the workforce completes the task. Further, the information used in the tracking and evaluation can be data stores at the shopping facility, at a remote storage, through multiple remote storage and the like (e.g., cloud, regional and/or chain home office, etc.).

Further, some embodiments provide a confirmation or check on work supposedly performed and reported by one or more workers at a shopping facility. By taking advantage of the identified pairing between tasks, these embodiments can confirm the work performed in completing a first task is consistent with the expected work performed on a second task, and vice versa. It has been recognized that some workers report that they have performed one or more tasks (e.g., worker registering that he/she has performed a specified quantity of picking tasks, by moving products from a back storage area to an area prior to be moved out onto the sales floor) that have not actually been performed. Based on the registered quantity of work (e.g., picks) that was completed, the workforce evaluation system would predict a corresponding amount of a second task (e.g., stocking tasks). If the workforce evaluation system does not receive and/or detect the completion of the predicted stocking, the anomaly can be reported. Further, in some instances, the workforce evaluation system may be configured to detect a trend of a worker inaccurately reporting work being performed that is not consistent with one or more corresponding paired tasks, which can be reported as part of the anomaly reporting and/or other such reporting. Accordingly, the workforce evaluation system further provides a check on work supposedly performed and potentially detect workers trying to “cheat” the system by reporting work that was not actually performed.

Similarly, some embodiments can evaluate the efficiency and/or effectiveness of the workforce based on pairing between two or more tasks. For example, the workforce evaluation system can recognize an amount of product sold through the point of sale system, and based on the quantity of sales of the product predict an amount of picks that should occur to replenish the shelves of the sold products. Based on an evaluation of the reported picks, the reported quantity of picks, and the timing of the picks, the workforce evaluation system can identify when insufficient picks are occurring and/or not occurring within a desired time frame. These anomalies can be reported to allow the management to follow up on those tasks and/or workers. Still further, in some implementations, the workforce management system may further detect anomalies and identify how those anomalies may be corrected, and generate one or more notifications to management and/or workers in an attempt to initiate one or more tasks to address the anomaly. For example, the workforce evaluation system may predict that a quantity of picks should be performed (e.g., based on paired task of sales, and/or product deliveries), and when the quantity of picks are not reported within a threshold time, the workforce evaluation system may generate a notification to management and/or workers assigned to perform picks identifying the one or more products expected to be picked and the remaining quantities of that product that are expected (e.g., (predicted pick quantity)−(reported pick quantity)).

Similarly, the workforce evaluation system may detect that a workforce is being regularly diverted from tasks in one or more departments of the shopping facility to perform one or more tasks in another department based on reported work and/or other detections (e.g., scanning of products as they are being shelved). Based on this identification, the workforce evaluation system may detect a trend of this occurring and recognize one or more other departments of the shopping facility are being neglected. One or more reports can be generated notifying of the anomalies and/or the anomaly trend. Further, based on the trend the workforce evaluation system may propose one or more predefined actions, such as notifying a manager of the department that is pulling workers to avoid pulling workers, recommend increasing the number of workers at least during times when the trend occurs, and other such actions. As another example, the workforce evaluation system may detect that a department manager is issuing more “count” requests and/or price changes than are typical, which are more maintenance or administrative work as opposed to creating picks as needed. The workforce evaluation system can compare these tasks to corresponding picks being performed relative to products of that department and detect that the department manager is neglecting work that needs to be done (e.g., based on recognizing quantities of sales); while similar administrative tasks performed in a second department would not be considered over indexed or as neglecting work because picking and stocking are consistent with sales (e.g., scheduling the administrative tasks is an efficient use of workforce in this department because the sales confirm that picking and/or stocking tasks are not being neglected).

In some instances, the workforce evaluation system may further identify that workforce may be shifted from one task to other more critical tasks, and as part of an anomaly reporting recommend the redistribution of workforce. In continuing with the example above, the workforce evaluation system may recommend that workers from a first department where administrative work is being performed be shifted to a first department that is having difficulty maintaining picks and/or stocking based on the amount of work being performed in corresponding tasks (e.g., sales and/or deliveries of products in that department, and/or quantities of picks and/or stocking occurring in other departments). Accordingly, some embodiments utilize the knowledge of how much work was done in a first area to predict how much work should be done in a second area. An evaluation of the work being done in the second area can determine whether the amount of work is less than or more than what is expected, which can indicate an anomaly and/or issue that should at least be considered.

In order to create the pairs, you look at tasks that are dependent on another, or are shared over different regions of the store. The ones that we listed are the ones that we are looking at. Some examples of pairing can include, but are not limited to:
Administration work versus On-Shelf-Availability (OSA) work—where administration work can, in part, be considered work that is to be accomplish at a shopping facility to ensure that shelf labeling is accurate and inventory is correct for that item; while OSA work is the work that is performed to get the product on the shelves (e.g., stocking tasks, creating picks, working picks, etc.). This relationship and/or comparison allows the workforce management system and/or shopping facility to see what type of work an area is doing and adjust the workload for the shopping facility.
Administration work in one area of the shopping facility versus administration work in another area of the shopping facility—by comparing two areas, the workforce valuation system can provide a sense of an amount of work that should be taking place for the non-critical activities and move them about the shopping facility.
Delivery versus binning—the binning (e.g., products that are put in an over stock area) should be in line with the deliveries (e.g., amount of product that was received at the shopping facility). The workforce evaluation system, in some implementations, considers binning a threshold time period after one or more deliveries to evaluate whether sufficient binning is occurring relative to the quantity of deliveries and/or quantity of work performed relative to the task of receiving the deliveries. For example, the workforce evaluation system may further consider binning and relate it to the amount of delivery that is received.
Binning versus picking—picking can include, for example, workers taking product out of the bins and/or other storage areas and taking the products to the sales floor. By evaluating the picking, the workforce evaluation system can predict an amount of product that should have been bin, which can be a further evaluation of binning similar to the same way that deliveries can predict binning. Additionally or alternatively, the workforce evaluation system can evaluate the amount of binning (e.g., binning performed one day) to predict an amount of picking that would be expected (e.g., predict how much picking should occur the following day).
Picking versus stocking—The amount of picking should correlate to the amount of stocking (putting items on the shelf.) If you pick a large amount, you can determine how much stocking should take place. In the reverse is a better measure, by looking at how much you are picking, you can see how well you stocked in the past.
Stocking verses other sales floor tasks (such as but not limited to price changes, shelf label printing, modular sets, shelf capacity adjustments, on hand adjustments, etc.)—In some implementations, the workforce evaluation system can evaluate workforce productivity, efficiency, and/or whether workforce is effectively being assigned tasks by evaluating the amount of stocking that is performed (e.g., in a department) relative to an amount (e.g., work hours) of sales floor administrative tasks that are performed (e.g., an amount of stocking performed can be predicted based on an amount of sales floor administration tasks that were being performed instead of stocking).

The workforce evaluation system, in addition to considering paired or related tasks, can in some embodiments further break down the metrics into timing of the tasks and quantity of the tasks. These metrics can be provided in a report to the manager and/or home office to make decisions on what to do in the shopping facility. For example, the workforce evaluation system detects that an amount of binning is less than what is predicted based on the delivery, then it may be determined the binning workers may need more help and additional binning workers may be assigned.

In some embodiments, apparatuses, systems and methods are provided herein to evaluate and/or enhance work productivity at a shopping facility. Some embodiments provide a system operated at a shopping facility configured to evaluate and/or enhance work productivity, comprising: a workforce evaluation system comprising: a control circuit; and a memory coupled to the control circuit and storing computer instructions that when executed by the control circuit cause the control circuit to: identify a first work task being performed or completed at a shopping facility and identify an amount of work performed by a workforce at the shopping facility in working on the first work task, wherein the first work task is one work task of multiple different work tasks intended to be performed at the shopping facility based at least in part on registered sales and shipment deliveries at the shopping facility, wherein the multiple different work tasks are to be performed by the workforce at the shopping facility; identify a paired second work task that is paired with the first work task and wherein an amount of work to be performed for the paired second work task is specifically dependent on an amount of work performed for the first work task; predict an amount of work to be performed in working on the second task as a function of the amount of work performed in working on the first task; identify an amount of work that is performed by the workforce at the shopping facility in working on the second task; cause an anomaly notification to be generated when the determined amount of work performed in working on the second task is not within a threshold of the predicted amount of work to be performed.

Some embodiments provide methods comprising: by a control circuit of a workforce evaluation system: identifying a first work task being performed or completed at a shopping facility and identifying an amount of work performed by a workforce at the shopping facility in working on the first work task, wherein the first work task is one work task of multiple different work tasks intended to be performed at the shopping facility based at least in part on registered sales and shipment deliveries at the shopping facility, wherein the multiple different work tasks are to be performed by the workforce at the shopping facility; identifying a paired second work task that is paired with the first work task and wherein an amount of work to be performed for the paired second work task is specifically dependent on an amount of work performed for the first work task; predicting an amount of work to be performed in working on the second task as a function of the amount of work performed in working on the first task; identifying an amount of work that is performed by the workforce at the shopping facility in working on the second task; causing an anomaly notification to be generated when the determined amount of work performed in working on the second task is not within a threshold of the predicted amount of work to be performed.

Some embodiments provide a system comprising: means for identifying a first work task being performed or completed at a shopping facility, wherein the first work task is one work task of multiple different work tasks intended to be performed at the shopping facility based at least in part on registered sales and shipment deliveries at the shopping facility, wherein the multiple different work tasks are to be performed by a workforce of employees at the shopping facility; means for identifying a paired second work task that is paired with the first work task and wherein an amount of work to be performed for the paired second work task is specifically dependent on an amount of work performed for the first work task; means for identifying an amount of work performed by the workforce at the shopping facility in working on the first work task; means for predicting an amount of work to be performed in working on the second task as a function of the amount of work performed in working on the first task; means for identifying an amount of work that is performed by the workforce at the shopping facility in working on the second task; means for determining whether the amount of work that is performed in working on the second task is within a threshold of the predicted amount of work to be performed in working on the second task; and means for causing an anomaly notification to be generated when the determined amount of work performed in working on the second task is not within the threshold of the predicted amount of work to be performed.

In some instances, a system is provided comprising: a workforce evaluation system comprising: a control circuit; and a memory coupled to the control circuit and storing computer instructions that when executed by the control circuit cause the control circuit to: identify a first work task being performed or completed at a shopping facility, wherein the first work task is one work task of multiple different work tasks intended to be performed at the shopping facility based at least in part on registered sales and shipment deliveries at the shopping facility, wherein the multiple different work tasks are to be performed by a workforce of employees at the shopping facility; identify a paired second work task that is paired with the first work task and wherein an amount of work to be performed for the paired second work task is specifically dependent on an amount of work performed for the first work task; identify an amount of work performed by the workforce at the shopping facility in working on the first work task; predict an amount of work to be performed in working on the second task as a function of the amount of work performed in working on the first task; identify an amount of work that is performed by the workforce at the shopping facility in working on the second task; determine whether the amount of work that is performed in working on the second task is within a threshold of the predicted amount of work to be performed in working on the second task; and cause an anomaly notification to be generated when the determined amount of work performed in working on the second task is not within the threshold of the predicted amount of work to be performed.

In some embodiments, a method comprises: by a control circuit of a workforce evaluation system: identifying a first work task being performed or completed at a shopping facility, wherein the first work task is one work task of multiple different work tasks intended to be performed at the shopping facility based at least in part on registered sales and shipment deliveries at the shopping facility, wherein the multiple different work tasks are to be performed by a workforce of employees at the shopping facility; identifying a paired second work task that is paired with the first work task and wherein an amount of work to be performed for the paired second work task is specifically dependent on an amount of work performed for the first work task; identifying an amount of work performed by the workforce at the shopping facility in working on the first work task; predicting an amount of work to be performed in working on the second task as a function of the amount of work performed in working on the first task; identifying an amount of work that is performed by the workforce at the shopping facility in working on the second task; determining whether the amount of work that is performed in working on the second task is within a threshold of the predicted amount of work to be performed in working on the second task; and causing an anomaly notification to be generated when the determined amount of work performed in working on the second task is not within the threshold of the predicted amount of work to be performed.

Some embodiments provide a system operated at a shopping facility configured to evaluate work productivity, comprising: a point-of-sale system comprising point-of-sale units each configured to register sales of products to customers at a shopping facility; a supply tracking system configured to track product shipment requests and deliveries at the shopping facility; a task management system coupled with the point-of-sale system and the supply tracking system, wherein the task management system: identifies multiple different work tasks intended to be performed at the shopping facility based at least in part on the registered sales and the shipment deliveries at the shopping facility, wherein the multiple different work tasks are to be performed by a workforce of employees at the shopping facility; and tracks completion of some or all of the different work tasks; a workforce evaluation system coupled with the task management system, wherein the workforce evaluation system comprises: a control circuit; and a memory coupled to the control circuit and storing computer instructions that when executed by the control circuit cause the control circuit to: identify a first work task being performed or completed; identify a paired second work task that is paired with the first work task and wherein an amount of work to be performed for the paired second work task is specifically dependent on an amount of work performed for the first work task; identify an amount of work performed by the workforce at the shopping facility in working on the first work task; predict an amount of work to be performed in working on the second task as a function of the amount of work performed in working on the first task; identify an amount of work that is performed by the workforce at the shopping facility in working on the second task; determine whether the amount of work that is performed in working on the second task is within a threshold of the predicted amount of work to be performed in working on the second task; and cause an anomaly notification to be generated when the determined amount of work performed in working on the second task is not within the threshold of the predicted amount of work to be performed.

Some embodiments provide an apparatus operated at a shopping facility configured to evaluate work productivity, comprising: a point-of-sales system comprising point-of-sale units each configured to register sales of products to customers at a shopping facility; a supply tracking system configured to track product shipment requests and deliveries at the shopping facility; a task management system coupled with the point-of-sales system and the supply tracking system, wherein the task management system: identifies multiple different work tasks intended to be performed at the shopping facility based at least in part on the registered sales and the shipment deliveries at the shopping facility, wherein the multiple different work tasks are to be performed by a work force of employees at the shopping facility; and tracks completion of some or all of the different work tasks; a work force evaluation system coupled with the task management system, wherein the work force evaluation system comprises: a control circuit; and a memory coupled to the control circuit and storing computer instructions that when executed by the control circuit cause the control circuit to: identify a first work task being performed or completed; identify a paired second work task that is paired with the first work task and wherein an amount of work to be performed for the paired second work task is specifically dependent on an amount of work performed for the first work task; identify an amount of work performed by the work force at the shopping facility in working on the first work task; predict an amount of work to be performed in working on the second task as a function of the amount of work performed in working on the first task; identify an amount of work that is performed by the work force at the shopping facility in working on the second task; determine whether the amount of work that is performed in working on the second task is within a threshold of the predicted amount of work to be performed in working on the second task; and generate an anomaly notification when the determined amount of work performed in working on the second task is not within the threshold of the predicted amount of work to be performed.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. A system operated at a shopping facility configured to evaluate work productivity, comprising:
a workforce evaluation system comprising:
a control circuit; and
a memory coupled to the control circuit and storing computer instructions that when executed by the control circuit cause the control circuit to:
identify a first work task being performed or completed at a shopping facility and identify an amount of work performed by a workforce at the shopping facility in working on the first work task, wherein the first work task is one work task of multiple different work tasks intended to be performed at the shopping facility based at least in part on registered sales and shipment deliveries at the shopping facility, wherein the multiple different work tasks are to be performed by the workforce at the shopping facility;
identify a paired second work task that is paired with the first work task and wherein an amount of work to be performed for the paired second work task is specifically dependent on an amount of work performed for the first work task;
predict an amount of work to be performed in working on the second task as a function of the amount of work performed in working on the first task;
identify an amount of work that is performed by the workforce at the shopping facility in working on the second task;
cause an anomaly notification to be generated when the determined amount of work performed in working on the second task is not within a threshold of the predicted amount of work to be performed.

2. The system of claim 1, wherein the control circuit further identifies that the first work task is completed, and identifies the amount of work performed by the workforce in working on the first work task after the first task is completed.

3. The system of claim 2, wherein the control circuit, in identifying the amount of work that is performed by the workforce in working on the second task, is further configured to identify the amount of work performed in working on the second task within a threshold time of identifying the completion of the first task.

4. The system of claim 1, wherein the control circuit is further configured to:
identify a paired third work task that is paired with the second work task and wherein an amount of work to be performed for the paired third work task is specifically dependent on the predicted amount of work performed for the second work task;
predict an amount of work to be performed in working on a third task as a function of the predicted amount of work to be performed in working on the second task;
identify an amount of work that is performed by the workforce at the shopping facility in working on the third task;
cause an anomaly notification to be generated when the determined amount of work performed in working on the third task is not within a threshold of the predicted amount of work to be performed in working on the third task.

5. The system of claim 1, wherein the control circuit is further configured to:
identify a paired third work task that is paired with the first work task and wherein the amount of work to be performed for the paired first work task is specifically dependent on an amount of work performed in completing the third work task;
determine an expected amount of work that should have been performed in working on a third task as a function of the amount of work performed in working on the first task;
identify an amount of work that was performed by the workforce at the shopping facility in working on the third task; and
cause an anomaly notification to be generated when the determined amount of work performed in working on the third task is not within a threshold of the work performed in working on the first task.

6. The system of claim 1, wherein the control circuit is further configured to identify one or more areas of the shopping facility that are being neglected as a function of a lack of work being performed in completing the second task.

7. The system of claim 1, wherein the control circuit in causing the anomaly notification to be generated comprises causing at least one of an email to be sent, a text message to be sent, and a report to be generated.

8. A method of evaluating work productivity at a shopping facility, comprising:
by a control circuit of a workforce evaluation system:
identifying a first work task being performed or completed at a shopping facility and identifying an amount of work performed by a workforce at the shopping facility in working on the first work task, wherein the first work task is one work task of multiple different work tasks intended to be performed at the shopping facility based at least in part on registered sales and shipment deliveries at the shopping facility, wherein the multiple different work tasks are to be performed by the workforce at the shopping facility;
identifying a paired second work task that is paired with the first work task and wherein an amount of work to be performed for the paired second work task is specifically dependent on an amount of work performed for the first work task;
predicting an amount of work to be performed in working on the second task as a function of the amount of work performed in working on the first task;
identifying an amount of work that is performed by the workforce at the shopping facility in working on the second task;
causing an anomaly notification to be generated when the determined amount of work performed in working on the second task is not within a threshold of the predicted amount of work to be performed.

9. The method of claim 8, further comprising:
identifying that the first work task is completed; and
wherein the identifying the amount of work performed by the workforce in working on the first work task comprises identifying the amount of work performed by the workforce in working on the first work task after the first task is completed.

10. The method of claim 9, wherein the identifying the amount of work that is performed by the workforce in working on the second task further comprises identifying the amount of work performed in working on the second task within a threshold time of identifying the completion of the first task.

11. The method of claim 8, further comprising:
identifying a paired third work task that is paired with the second work task and wherein an amount of work to be performed for the paired third work task is specifically dependent on the predicted amount of work performed for the second work task;
predicting an amount of work to be performed in working on a third task as a function of the predicted amount of work to be performed in working on the second task;
identifying an amount of work that is performed by the workforce at the shopping facility in working on the third task;
causing an anomaly notification to be generated when the determined amount of work performed in working on the third task is not within a threshold of the predicted amount of work to be performed in working on the third task.

12. The method of claim 8, further comprising:
identifying a paired third work task that is paired with the first work task and wherein the amount of work to be performed for the paired first work task is specifically dependent on an amount of work performed in completing the third work task;
determining an expected amount of work that should have been performed in working on a third task as a function of the amount of work performed in working on the first task;
identifying an amount of work that was performed by the workforce at the shopping facility in working on the third task; and
causing an anomaly notification to be generated when the determined amount of work performed in working on the third task is not within a threshold of the work performed in working on the first task.

13. The method of claim 8, further comprising:
identifying one or more areas of the shopping facility that are being neglected as a function of a lack of work being performed in completing the second task.

14. The method of claim 8, wherein the causing the anomaly notification to be generated comprises causing at least one of an email to be sent, a text message to be sent, and a report to be generated.

15. A system of evaluating work productivity at a shopping facility, comprising:
means for identifying a first work task being performed or completed at a shopping facility, wherein the first work task is one work task of multiple different work tasks intended to be performed at the shopping facility based at least in part on registered sales and shipment deliveries at the shopping facility, wherein the multiple different work tasks are to be performed by a workforce at the shopping facility;
means for identifying a paired second work task that is paired with the first work task and wherein an amount of work to be performed for the paired second work task is specifically dependent on an amount of work performed for the first work task;
means for identifying an amount of work performed by the workforce at the shopping facility in working on the first work task;
means for predicting an amount of work to be performed in working on the second task as a function of the amount of work performed in working on the first task;
means for identifying an amount of work that is performed by the workforce at the shopping facility in working on the second task;
means for determining whether the amount of work that is performed in working on the second task is within a threshold of the predicted amount of work to be performed in working on the second task; and
means for causing an anomaly notification to be generated when the determined amount of work performed in working on the second task is not within the threshold of the predicted amount of work to be performed.
